(19) United States
(12) Patent Application Publication
(10) Pub. No.: US 2015/0102111 A1
(43) Pub. Date: Apr. 16, 2015

(54) ENCODING METHOD AND ENCODING DEVICE

(71) Applicant: ASUSTeK COMPUTER INC., TAIPEI (TW)

(72) Inventors: Sheng-Kai CHEN, TAIPEI (TW); Chen-Hsien YANG, TAIPEI (TW); Chien-Hua TING, TAIPEI (TW)

(21) Appl. No.: 14/515,536

(22) Filed: Oct. 16, 2014

Related U.S. Application Data
(60) Provisional application No. 61/891,418, filed on Oct. 16, 2013.

(30) Foreign Application Priority Data
Sep. 24, 2014 (TW) 103133041

(51) Int. Cl. G06K 19/06

(52) U.S. Cl. CPC G06K 19/06037; G06K 19/0614
USPC 235/494

(57) ABSTRACT

An encoding method is provided. The encoding method comprises: encoding a first portion of target data to generate a first two dimensional code; encoding a second portion of the target data by the encoding unit generate a second two dimensional code; generating a three dimensional model according to the first two dimensional code, wherein the three dimensional model includes a plurality of three dimensional modules, the three dimensional modules are arranged along a first direction and a second direction, and a height in a third direction of the three dimensional modules is determined according to the first codes; coloring the three dimensional modules according to the second two dimensional code, respectively, to generate a colored three dimensional model, wherein a color of the three dimensional modules of the colored three dimensional model is determined according to the second codes.

### CROSS-REFERENCE TO RELATED APPLICATION

This application claims the priority benefit of U.S. provisional application Ser. No. 61/891,418, filed on Oct. 16, 2013 and TW application serial No. 103133041, filed on Sep. 24, 2014. The entirety of the above-mentioned patent applications are hereby incorporated by reference herein and made a part of specification.

### BACKGROUND OF THE INVENTION

1. Field of the Invention

The invention relates to an encoding method and, more particularly, to an encoding method and an encoding device using the same.

2. Description of the Related Art

As electronic technology develops, two dimensional codes are weirdly used in life, for example, the two dimensional codes are used to recognize products or record and transfer information (such as a website).

Conventionally, two dimensional code images include a plurality of plane blocks which are arranged closely to each other. The two dimensional code images record the information via different colors (such as dark colors and light colors) of the plane blocks, and then a decoding device decodes the information by capturing the two dimensional code images.

### BRIEF SUMMARY OF THE INVENTION

An encoding method is provided. In an embodiment, the encoding method comprising: encoding a first portion of target data by an encoding unit to generate a first two dimensional code, wherein the first two dimensional code includes a plurality of first codes; encoding a second portion of the target data by the encoding unit to generate a second two dimensional code, wherein the second two dimensional code includes a plurality of second codes; generating a three dimensional model according to the first two dimensional code, wherein the three dimensional model includes a plurality of three dimensional modules, the three dimensional modules are arranged along a first direction and a second direction, and a height in a third direction of the three dimensional modules is determined according to the first codes; and coloring the three dimensional modules according to the second two dimensional code, respectively, to generate a colored three dimensional model, wherein a color of the three dimensional modules of the colored three dimensional model is determined according to the second codes.

An encoding device is provided. The encoding device includes a memory unit and an encoding unit. The memory unit is used to store target data. The encoding unit is used to: encoding a first portion of target data to generate a first two dimensional code, wherein the first two dimensional code includes a plurality of first codes; encoding a second portion of the target data to generate a second two dimensional code, wherein the second two dimensional code includes a plurality of the second codes; generating a three dimensional model according to the first two dimensional code, wherein the three dimensional model includes a plurality of the three dimensional modules, the three dimensional modules are arranged along a first direction and a second direction, and a height in a third direction of the three dimensional modules is determined according to the first codes; and coloring the three dimensional modules according to the second two dimensional code, respectively, to generate a colored three dimensional model, wherein a color of the three dimensional modules of the colored three dimensional model is determined according to the second codes.

The target data can be encoded to the three dimensional model via the encoding method. Since the three dimensional model utilizes different heights of each module to store the data, as a result, the three dimensional model can store more data compared to the two dimensional code images.

### BRIEF DESCRIPTION OF THE DRAWINGS

These and other features, aspects and advantages of the invention will become better understood with regard to the following embodiments and accompanying drawings.

FIG. 1 is a schematic diagram showing an encoding device in an embodiment;

FIG. 2 is a flow chart showing an encoding method in an embodiment;

FIG. 3 is a schematic diagram showing a three dimensional model in an embodiment;

FIG. 4 is a schematic diagram showing a three dimensional model in another embodiment;

FIG. 5 is a schematic diagram showing a decoding device in an embodiment; and

FIG. 6 is a flow chart showing a decoding method in an embodiment.

### DETAILED DESCRIPTION OF THE EMBODIMENTS

“The first”, “the second” and so on are not used to limit in the order nor the invention, and they are only used to distinguish components or operations with same technical terms.

The terms “connected” can represent that two or more components are contacted physically or electronically, and the contact therebetween may be direct or indirect, and it also may represent that two or more components operate or act with each other, which is not limited herein.

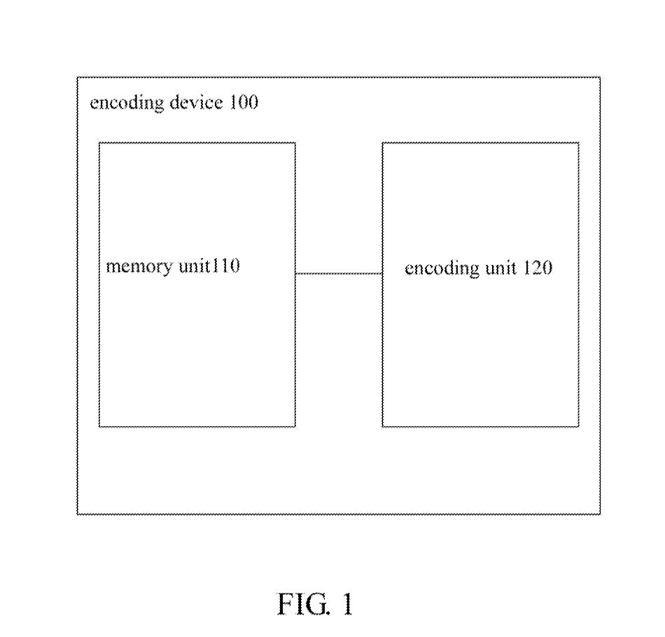

FIG. 1 is a schematic diagram showing an encoding device 100 in an embodiment. The encoding device 100 includes a memory unit 110 and an encoding unit 120. The memory unit 110 is electrically connected to the encoding unit 120.

In the embodiment, the memory unit 110 is such as a hard disk, a memory, a portable storage media or other storage devices. The function of the encoding unit 120 is achieved by a processor executing computer programs stored in a computer readable storage medium. The processor is such as a central processing unit (CPU), a digital signal processor (DSP), a micro processor or other computing units. The computer readable storage medium is such as a read-only memory, a flash memory, a floppy disk, a hard disk, an optical disk, a flash driver, a tape, a network access database or other storages.

In the embodiment, the memory unit 110 is used to store specific target data. The encoding unit 120 is used to encode according to the target data stored in the memory unit 110 to generate a three dimensional model.

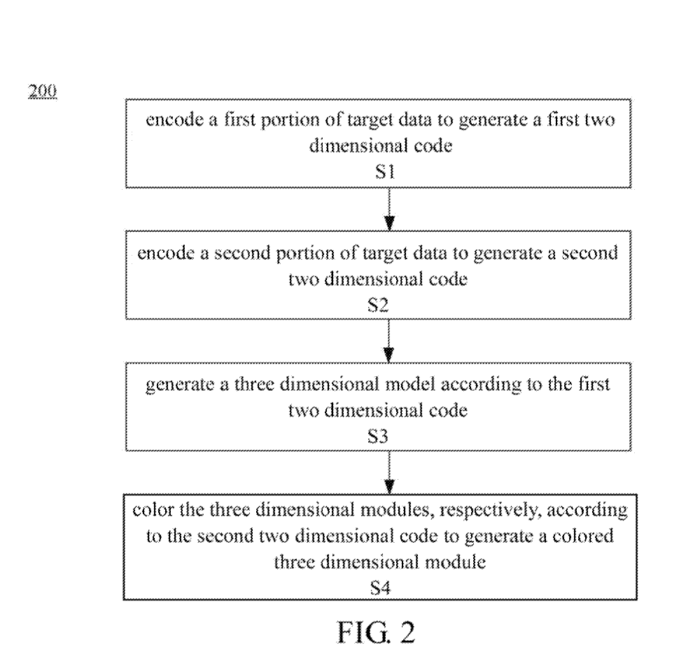

The encoding operation is illustrated in details cooperating with the embodiment accompanying FIG. 2, and the invention is not limited thereto.

FIG. 2 is a flow chart showing an encoding method 200 in an embodiment. The encoding method 200 can be applied to the encoding device in FIG. 1 or other similar encoding devices. The encoding device 100 in FIG. 1 is taken as an example to illustrate the encoding method 200, which is not limited herein.

Steps of the encoding method 200 are not executed in a particular sequence except specifically stated. In addition, the steps may be executed at the same time or have time overlap.

Moreover, in other different embodiments, the steps can also be added, replaced or omitted adaptively.

In the embodiment, the encoding method 200 includes the following steps.

In step S1, the encoding device 100 encodes a first portion of the target data stored in the memory unit 110 via the encoding unit 120 to generate a first two dimensional code. In an embodiment, the first two dimensional code is a matrix two dimensional code including a plurality of first codes arranged in matrix. In the embodiment, the first two dimensional code is a quick response (QR) code.

In step S2, the encoding device 100 encodes a second portion of the target data stored in the memory unit 110 via the encoding unit 120 to generate a second two dimensional code. In an embodiment, the second two dimensional code is a matrix two dimensional code including a plurality of second codes arranged in matrix. In an embodiment, the second two dimensional code is a QR code. In an embodiment, a length (number of bits) of the first portion of the target data is greater than or equal to that of the second portion.

In step S3, the encoding device 100 can generate a three dimensional model via the encoding unit 120 according to the first two dimensional code. In an embodiment, the encoding unit 120 can generate a three dimensional model via image processing technology. In an embodiment, the encoding unit 120 can generate a three dimensional model physically via a three dimensional model generating element (such as a 3D printer) (not shown).

In an embodiment, the three dimensional model includes a plurality of the three dimensional modules. In an embodiment, the three dimensional modules are arranged along a first direction and a second direction, the three dimensional modules includes a height in a third direction, and the first direction, the second direction and the third direction are different. In the embodiment, the x axis direction of a xyz three dimensional coordinate is taken as the first direction, the y axis direction is taken as the second direction, and the z axis direction is taken as the third direction, which is not limited herein.

In an embodiment, the three dimensional modules are arranged along the x axis direction and y axis direction of a xyz three dimensional coordinate, that means, the three dimensional modules are arranged on a xy plane of the xyz three dimensional coordinate. In an embodiment, the three dimensional modules include a height in the z axis direction, respectively. In the embodiment, the height in the z axis direction of the three dimensional modules is determined according to the corresponding first code of the first two dimensional code. For example, if one encoding type of the first code represents “logic 1”, the corresponding three dimensional module includes the first height, if one encoding type of the first code represents “logic 0”, the corresponding three dimensional module includes the second height which is different from the first height.

In step S4, the encoding device 100 colors the three dimensional module via the encoding unit 120, respectively, according to the second two dimensional code to generate a colored three dimensional model. In the embodiment, the encoding unit 120 colors the three dimensional modules via the image processing technology. In the embodiment, the encoding unit 120 can color the three dimensional modules physically via the three dimensional model generating element.

In an embodiment, the color of the each three dimensional module is determined according to the corresponding second code of the second two dimensional code. For example, if one encoding type of the second code represents “logic 1”, the corresponding color of the three dimensional module is a first color (such as a dark color), if one encoding type of the second code represents “logic 0”, the corresponding color of the three dimensional module is a second color which is different from the first color (such as a light color).

The disclosures will become better understood with regard to the following two embodiments, which is not limited herein.

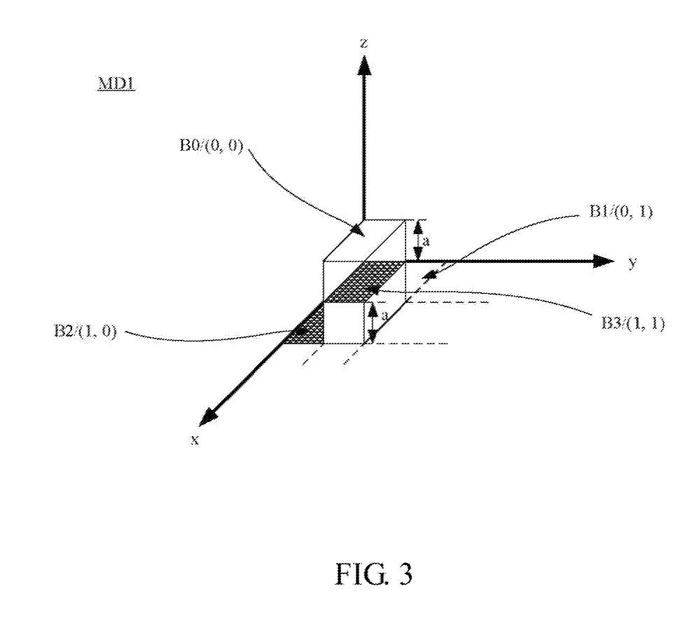

Please refer to FIG. 3, in the embodiment, the target data is such as a bit array “00111001”, the first portion of the target data is such as a bit array “1001” (the last 4 bits of the target data), the second portion of the target data is such as a bit array “0011” (the first 4 bits of the target data). The encoding unit 120 can generate the first two dimensional code according to the bit array “1001”, the first two dimensional code can be expressed by a 2×2 matrix {(1, 0) (0, 1)} (that is, the first column of the matrix is (1, 0), the second column of the matrix is (0, 1), and “1” represents the first height, “0” represents the second light). In addition, the encoding unit 120 can generate the second two dimensional code according to the bit array “0011”, the second two dimensional code can be expressed by a 2×2 matrix {(0, 0) (1, 1)}.

The encoding unit 120 can generate a three dimensional model MD1 according to the first two dimensional code. The three dimensional model MD1 includes four three dimensional modules B0 to B3, which are arranged in the positions (0, 0), (0, 1), (1, 0), (1, 1) of the xy plane, respectively. The heights of the three dimensional modules B0 to B3 are corresponding to the first codes of the first two dimensional code, respectively. For example, the three dimensional module B0 includes the height a (a is positive) according to the code (expressed as “1”) located at the first column and the first line of the first two dimensional code, the three dimensional module B1 includes the height 0 according to the code (expressed as “0”) located at the first column and the second line of the first two dimensional code, the three dimensional module B2 includes the height 0 according to the code (expressed as “0”) located at the second line and the first line of the first two dimensional code, and the three dimensional module B3 includes the height a according to the code (expressed as “1”) located at the second line and the second line of the first two dimensional code.

The encoding unit 120 colors surfaces perpendicular to the z axis of the three dimensional modules B0 to B3 according to the codes of the second two dimensional code. For example, the surface perpendicular to the z axis of the three dimensional module B0 is in light color according to the code (expressed as “0”) located at the first column and the first line of the second two dimensional code; the surface perpendicular to the z axis of the three dimensional module B1 is in light color according to the code (expressed as “0”) located at the first column and the second line of the second two dimensional code; the surface perpendicular to the z axis of the three dimensional module B2 is in dark color according to the code (expressed as “1”) located at the second line and the first line of the second two dimensional code; and the surface perpendicular to the z axis of the three dimensional module B3 is in dark color according to the code (expressed as “1”) located at the second line and the second line of the second two dimensional code.

The three dimensional modules B0 to B3 of the three dimensional model MD1 store the target data via the above method. In the embodiment, although the three dimensional model includes two different heights, the three dimensional model may include three or above different heights in another embodiment, so as to utilize the variation of the height to store more data.

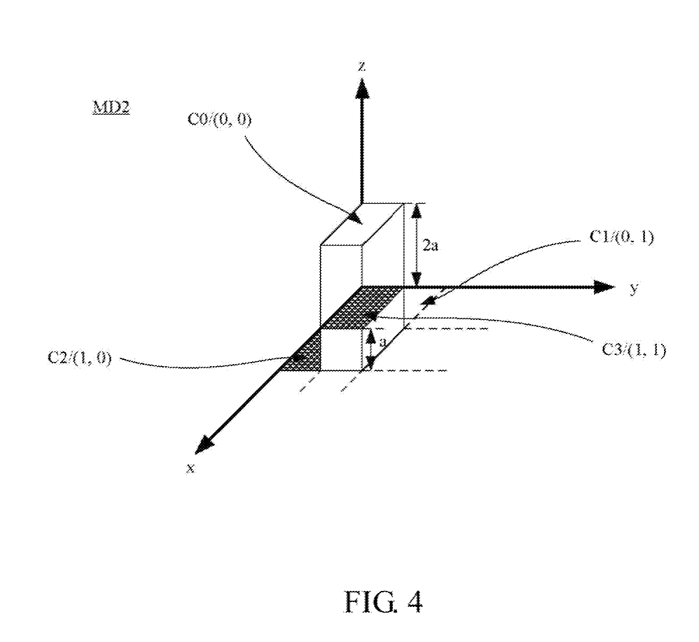

Please refer to FIG. 4, in another embodiment, the target data is such as a bit array “001110011000”, the first portion of the target data is such as a bit array “10011000” (the last 8 bits of the target data), the second portion of the target data is such as a bit array “0011” (the first 4 bits of the target data). The encoding unit 120 can generate the first two dimensional code according to a portion (the first 4 bits “1001”) of the bit array “10011000”, the first two dimensional code can be expressed by a 2×2 matrix {(1, 0) (0, 1)}, and the encoding unit 120 can generate the third two dimensional code according to the other portion (the last 4 bits “1000”) of the bit array “10011000”, the third two dimensional code can be expressed by a 2×2 matrix {(1, 0) (0, 0)}. In addition, the encoding unit 120 can generate the second two dimensional code according to the bit array “0011”, the second two dimensional code can be expressed by a 2×2 matrix {(0, 0) (1, 1)}.

The encoding unit 120 can generate a three dimensional model MD2 according to the first two dimensional code and the third two dimensional code. The three dimensional model MD2 includes four three dimensional modules C0 to C3, which are arranged in the positions (0, 0), (0, 1), (1, 0), (1, 1) of the xy plane, respectively. The heights of the three dimensional modules C0 to C3 are corresponding to the first codes of the first two dimensional code and the third codes of the third two dimensional code, respectively. For example, the three dimensional module C0 includes the height 2a according to the code (expressed as “1”) located at the first column and the first line of the first two dimensional code and the code (expressed as “1”) located at the first column and the first line of the third two dimensional code: the three dimensional module C1 includes the height 0 according to the code (expressed as “0”) located at the first column and the second line of the first two dimensional code and the code (expressed as “0”) located at the first column and the second line of the third two dimensional code; the three dimensional module C2 includes the height 0 according to the code (expressed as “0”) located at the second line and the first line of the first two dimensional code and the code (expressed as “0”) located at the second line and the first line of the third two dimensional code; and the three dimensional module C3 includes the height a according to the code (expressed as “1”) located at the second line and the second line of the first two dimensional code and the code (expressed as “0”) located at the second line and the second line of the third two dimensional code.

The encoding unit 120 can color surfaces perpendicular to the z axis of the second two dimensional code according to the codes of the three dimensional modules C0 to C3. For example, the surface perpendicular to z axis of the three dimensional module C0 is in light color according to the code (expressed as “0”) located at the first column and the first line of the second two dimensional code; the surface perpendicular to the z axis of the three dimensional module C1 is in light color according to the code (expressed as “0”) located at the first column and the second line of the second two dimensional code; the surface perpendicular to the z axis of the three dimensional module C2 is in dark color according to the code (expressed as “1”) located at the second line and the first line of the second two dimensional code; the surface perpendicular to the z axis of the three dimensional module C3 is in dark color according to the code (expressed as “1”) located at the second line and the second line of second two dimensional code.

The target data is converted to the three dimensional model including three heights via the above method. The three dimensional model including three heights can store more data compared to the three dimensional model including two heights.

The three dimensional model generated through the encoding method can be decoded via the following decoding method, which is not limited herein.

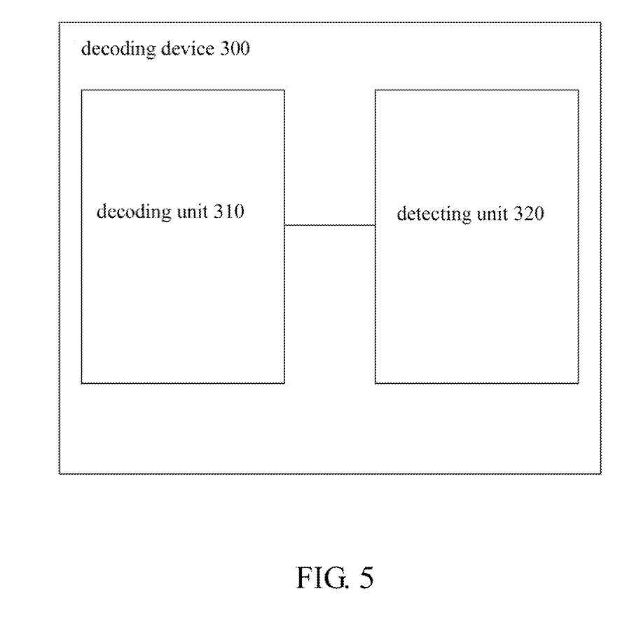

FIG. 5 is a schematic diagram showing a decoding device 300 in an embodiment. The decoding device 300 includes a decoding unit 310 and a detecting unit 320. In the embodiment, the decoding unit 310 is electrically connected to the detecting unit 320 decoding unit

In the embodiment, the detecting unit 320 is such as a camera lens and/or an ultrasonic distance measuring component. The function of the decoding unit 310 can be achieved by a processor executing computer programs stored in a computer readable storage medium. The details about the processor and the computer readable storage medium can refer to the above description, which are omitted herein.

In the embodiment, the detecting unit 320 is used to detect the height of the three dimensional modules of the colored three dimensional model, and recognize the color of the three dimensional modules. The decoding unit 310 is used to decode out the target data according to the height of the three dimensional modules and the color of the three dimensional modules of the colored three dimensional model.

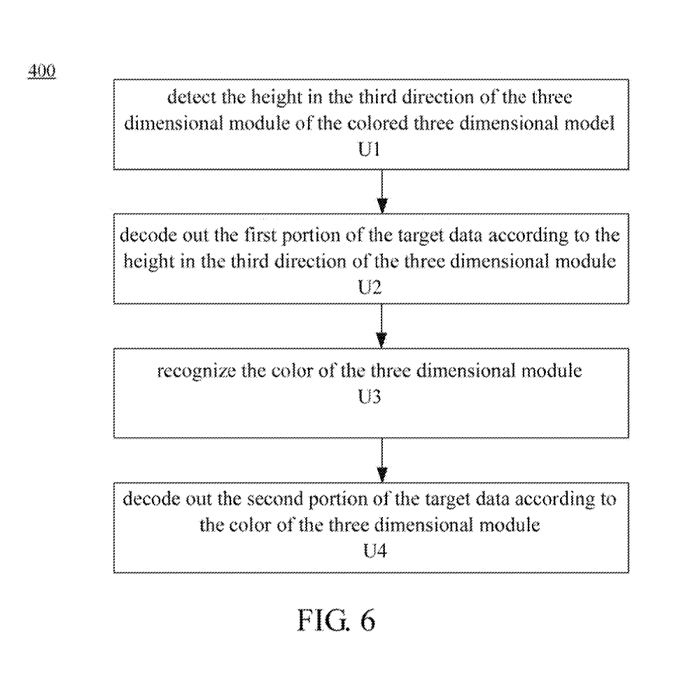

The decoding operation is illustrated in details cooperating with the embodiment accompanying FIG. 6, the invention is not limited thereto.

FIG. 6 is a flow chart showing a decoding method 400 in an embodiment. The decoding method 400 can be applied to the decoding device or other similar devices. The decoding device 300 in FIG. 5 is taken as an example to illustrate the decoding method 400, which is not limited herein.

Steps of the decoding method 400 are not executed in a particular sequence except specifically stated. In addition, the steps may be executed at the same time or have time overlap.

Moreover, in other different embodiments, the steps can also be added, replaced or omitted adaptively.

In the embodiment, the decoding method 400 includes the following steps.

In step U1, the decoding device 300 detects the height of the three dimensional modules of the colored three dimensional model via the detecting unit 320. In the embodiment, the detecting unit 320 can use the time of fly detection, a light coding detection, a parallax detection, an ultrasonic detection, and/or other methods to detect the height of the three dimensional modules.

In step U2, the decoding device 300 can decode out the first portion of the target data according to the height of the three dimensional modules via the decoding unit 310. In an embodiment (for example, the three dimensional modules only includes two heights), the decoding unit 310 generates a group of two dimensional codes according to the height of the three dimensional modules, and the first portion of the target data is decoded out according to the group of two dimensional codes. In another embodiment (for example, the three dimensional modules includes three or more heights), the decoding unit 310 can also generate multiple groups of two dimensional codes according to the height of the three dimensional modules, and the first portion of the target data is decoded according to the two dimensional codes. In an embodiment, the decoding unit 310 can generate the two dimensional codes by determining whether the height of the three dimensional modules is greater than or equal to one or more particular height threshold.

In step U3, the decoding device 300 can recognize the color of the three dimensional modules of the colored three dimensional model via the detecting unit 320. In the embodiment, the detecting unit 320 first capture the image of the three dimensional model, and then the color of the three dimensional modules is recognized by the image processing technology.

In step U4, the decoding device 300 can decode out the second portion of the target data according to the color of the three dimensional modules via the decoding unit 310. In the embodiment, the decoding unit 310 obtains the two dimensional code corresponding to the color of the surfaces of the three dimensional modules according to the color of the surfaces of the three dimensional modules, and the second portion of the target data is decoded out according to the two dimensional code.

The following two operation examples are taken as example to make the illustration more clear, however, the invention is not limited thereto.

Please refer to FIG. 3, in an embodiment, the decoding unit 310 can first determine the maximum height in the z axis of the three dimensional modules B0 to B3 of the three dimensional model MD1. If the maximum height in the z axis of the three dimensional modules B0 to B3 is a, the decoding unit 310 can determine whether any height greater than or equal to a is existed in the z axis of the three dimensional modules B0 to B3. If the height in the z axis of the three dimensional modules B0, B3 is equal to a, and the height in the z axis of the three dimensional modules B1, B2 is less than a, the two dimensional code corresponding to the plane of which the height of the z axis is a (that is a plane (0, 0, a) in xyz rectangular coordinate) can be expressed as {(1, 0) (0, 1)}. Then, the decoding unit 310 can decode out the bit array “1001”.

The surface perpendicular to the z axis of the three dimensional module B0 is in light color, the surface perpendicular to the z axis of the three dimensional module B is in light color, the surface perpendicular to the z axis of the three dimensional module B2 is in dark color, and the surface perpendicular to the z axis of the three dimensional module B3 is in dark color, the decoding unit 310 can obtain the two dimensional code (such as expressed as {(0, 0) (1, 1)}) corresponding to the color of the three dimensional modules C0 to C3. Thus, the decoding unit 310 can decode out the second portion (the bit array “0011”) of the target data.

Then, the decoding unit 310 can combine the first portion and the second portion of the target data to obtain the complete target data (the bit array “00111001”).

Additionally, please refer to FIG. 4, in another embodiment, the decoding unit 310 can first determine the maximum height in the z axis of the three dimensional modules C0 to C3 of the three dimensional model MD2. If the maximum height in the z axis of the three dimensional modules C0 to C3 is 2a, the decoding unit 310 can determine whether any height greater than or equal to 2a is existed in the z axis of the three dimensional modules C0 to C3. If the height in the z axis of the three dimensional module C0 is equal to 2a, and the three dimensional modules C1 to C3 is less than 2a, the two dimensional code corresponding to the plane of which the height of the z axis is 2a (that is a plane (0, 0, 2a) in xyz rectangular coordinate) can be expressed as {(1, 0) (0, 0). Thus, the decoding unit 310 can decode out the bit array “1000”.

Then, the decoding unit 310 can determine the second maximum height in the z axis of the three dimensional modules C0 to C3. If the second maximum height in the z axis of the three dimensional modules C0 to C3 is a, the decoding unit 310 can determine whether any height greater than or equal to a is existed in the z axis of the three dimensional modules C0 to C3. If the height in the z axis of the three dimensional modules C0, C3 is greater than or equal to a, and the height in the z axis of the three dimensional modules C1 to C2 is less than a, the two dimensional code corresponding to the plane of which the height of the z axis is a (that is a plane (0, 0, a) in xyz rectangular coordinate) can be expressed as {(1, 0 (0, 1). Thus, the decoding unit 310 can decode out the bit array “1001”.

The decoding unit 310 can combine the bit array “1001” corresponding to the plane of the z axis is a and the bit array “1000” corresponding to the plane of the z axis is 2a, so as to decode out the first portion of the target data (the bit array “10011000”).

If the surface perpendicular to the z axis of the three dimensional module C0 is in light color, the surface perpendicular to the z axis of the three dimensional module C1 is in light color, the surface perpendicular to the z axis of the three dimensional module C2 is in dark color, the surface perpendicular to the z axis of the three dimensional module C3 is in dark color, the decoding unit 310 can obtain the two dimensional code (such as expressed as {(0, 0) (1, 1)}) corresponding to the color of the three dimensional modules C0 to C3. Thus, the decoding unit 310 can decode out the second portion (the bit array “0011”) of the target data.

The decoding unit 310 can combine the first portion and the second portion of the target data to obtain the complete target data (the bit array “001110011000”).

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. An encoding method, comprising:
encoding a first portion of target data by an encoding unit to generate a first two dimensional code, wherein the first two dimensional code includes a plurality of first codes;
encoding a second portion of the target data by the encoding unit to generate a second two dimensional code, wherein the second two dimensional code includes a plurality of second codes;
generating a three dimensional model according to the first two dimensional code, wherein the three dimensional model includes a plurality of three dimensional modules, the three dimensional modules are arranged along a first direction and a second direction, and heights of the three dimensional modules alone a third direction is determined according to the first codes; and
coloring the three dimensional modules according to the second two dimensional code, respectively, to generate a colored three dimensional model, wherein a color of the three dimensional modules of the colored three dimensional model is determined according to the second codes.

2. The encoding method according to claim 1, wherein the heights of the three dimensional modules alone the third direction includes a first height and a second height, and the first height is different from the second height.

3. The encoding method according to claim 1, wherein the color of the three dimensional modules includes a first color and a second color, and the first color is different from the second color.

4. The encoding method according to claim 1, wherein a length of the first portion of the target data is greater than or equal to the length of the second portion of the target data.

5. The encoding method according to claim 1, wherein the first direction, the second direction and the third direction are perpendicular to each other.

6. An encoding device, comprising:
a memory unit storing target data; and
an encoding unit:
encoding a first portion of the target data to generate a first two dimensional code, wherein the first two dimensional code includes a plurality of first codes;
encoding a second portion of the target data to generate a second two dimensional code, wherein the second two dimensional code includes a plurality of the second codes;
generating a three dimensional model according to the first two dimensional code, wherein the three dimensional model includes a plurality of the three dimensional modules, the three dimensional modules are arranged along a first direction and a second direction, and heights of the three dimensional modules alone a third direction is determined according to the first codes; and
coloring the three dimensional modules according to the second two dimensional code, respectively, to generate a colored three dimensional model, wherein a color of the three dimensional modules of the colored three dimensional model is determined according to the second codes.

7. The encoding device according to claim 6, wherein the heights of the three dimensional modules alone the third direction includes a first height and a second height, and the first height is different from the second height.

8. The encoding device according to claim 6, wherein the color of the three dimensional modules includes a first color and a second color, and the first color is different from the second color.

9. The encoding device according to claim 6, wherein a length of the first portion of the target data is greater than or equal to the length of the second portion of the target data.

10. The encoding device according to claim 6, wherein the first direction, the second direction and the third direction are perpendicular to each other.
